(19) United States
(12) Patent Application Publication
(10) Pub. No.: US 2013/0206370 A1
(43) Pub. Date: Aug. 15, 2013

(54) ELECTRONIC APPARATUS

(71) Applicant: ABB Oy, (US)

(72) Inventors: Matti SMALÉN, Klaukkala (FI); Timo KOIVULUOMA, Vantaa (FI); Matti KAUHANEN, Espoo (FI)

(73) Assignee: ABB Oy, Helsinki (FI)

(21) Appl. No.: 13/766,163

(22) Filed: Feb. 13, 2013

(30) Foreign Application Priority Data
Feb. 14, 2012 (EP) 12155274.9

(51) Int. Cl. H02K 5/20

(52) U.S. Cl. CPC H02K 5/20
USPC 165/104.26

(57) ABSTRACT

An electronic apparatus includes an extruded metallic frame with walls which are integrated parts of the extruded metallic frame, at least one extruded flow channel in at least one of the walls for passing a cooling fluid within the respective wall, an inlet arranged outside the electronic apparatus and an outlet arranged outside the electronic apparatus for providing a flow path via the at least one extruded flow channel, and detachable covers which are attached to the walls for sealing off at least one electric component space from an outside of the electronic apparatus.

### RELATED APPLICATION

This application claims priority under 35 U.S.C. §119 to European Patent Application No. 12155274.9 filed in Europe on Feb. 14, 2012, the entire content of which is hereby incorporated by reference in its entirety.

### FIELD

This present disclosure relates to an electronic apparatus. More particularly, the present disclosure relates to an electronic apparatus having a unique frame structure.

### BACKGROUND INFORMATION

It is known for an electronic apparatus to include parts manufactured by molding or by shaping of steel plates. These separate parts are then attached to each other in order to obtain the load bearing frame of the electronic apparatus.

In order to provide the electronic components within the electronic apparatus with adequate cooling, cooling elements have been provided at the components which generate significant amounts of heat. To accomplish this, suitable pipes and fluid connectors have been arranged in the electric components space of the apparatus in order to accomplish the necessary cooling fluid circulation.

The known electronic apparatus therefore include many separate parts attached to each other, which is not a reliable nor suitable solution for all implementations.

### SUMMARY

An exemplary embodiment of the present disclosure provides an electronic apparatus which includes an extruded metallic frame having walls which are integrated parts of the metallic frame. The exemplary electronic apparatus also includes at least one flow channel in at least one of the walls for passing a cooling fluid within the at least one of the walls, respectively. The at least one flow channel is a flow channel which is extruded in the at least one of the walls. In addition, the exemplary electronic apparatus includes an inlet arranged outside the electronic apparatus and an outlet arranged outside the electronic apparatus for providing a flow path via the at least one flow channel. Furthermore, the exemplary apparatus includes detachable covers which are attached to the walls of the metallic frame for sealing off at least one component space from outside of the electronic apparatus. At least one of the detachable covers includes an edge which is in contact with the extruded metallic frame, and at least one of an integrated heat pipe and a thermosyphon for transferring heat from other parts of the detachable cover to the edge which is in contact with the extruded metallic frame for transferring heat from the detachable cover to the cooling fluid in the at least one extruded flow channel.

### BRIEF DESCRIPTION OF THE DRAWINGS

Additional refinements, advantages and features of the present disclosure are described in more detail below with reference to exemplary embodiments illustrated in the drawings, in which:

FIGS. 1 to 3 illustrate exemplary ways of shaping a frame according to the present disclosure;

FIGS. 4 and 5 illustrate fluid channels according to an exemplary embodiment of the present disclosure;

FIGS. 6 and 7 illustrate a location of components in an exemplary embodiment of the present disclosure;

FIGS. 8 to 10 illustrate detachable covers according to an exemplary embodiment of the present disclosure; and

FIG. 11 illustrates an exemplary embodiment of an electronic apparatus according to the present disclosure.

### DETAILED DESCRIPTION

Exemplary embodiments of the present disclosure overcome the aforementioned drawback by providing an electronic apparatus with a unique and more reliable structure. An exemplary embodiment of the present disclosure provides an electronic apparatus which includes an extruded metallic frame having walls which are integrated parts of the metallic frame. The exemplary electronic apparatus also includes at least one flow channel in at least one of the walls for passing a cooling fluid within the at least one of the walls, respectively. The at least one flow channel is a flow channel which is extruded in the at least one of the walls. In addition, the exemplary electronic apparatus includes an inlet arranged outside the electronic apparatus and an outlet arranged outside the electronic apparatus for providing a flow path via the at least one flow channel. Furthermore, the exemplary apparatus includes detachable covers which are attached to the walls of the metallic frame for sealing off at least one component space from outside of the electronic apparatus. At least one of the detachable covers includes an edge which is in contact with the extruded metallic frame, and at least one of an integrated heat pipe and a thermosyphon for transferring heat from other parts of the detachable cover to the edge which is in contact with the extruded metallic frame for transferring heat from the detachable cover to the cooling fluid in the at least one extruded flow channel.

The use of an extruded metallic frame with walls integrated in the metallic frame makes it possible to obtain a robust and rigid apparatus suitable for use in demanding environments. In such a solution, a flow channel for a cooling fluid can be provided in at least one of the walls during extrusion. This makes it possible to utilize the frame as a cooling device, and the need for fluid connectors within the electronic apparatus can be minimized.

Additional features of exemplary embodiments of the present are described below with reference to the drawings.

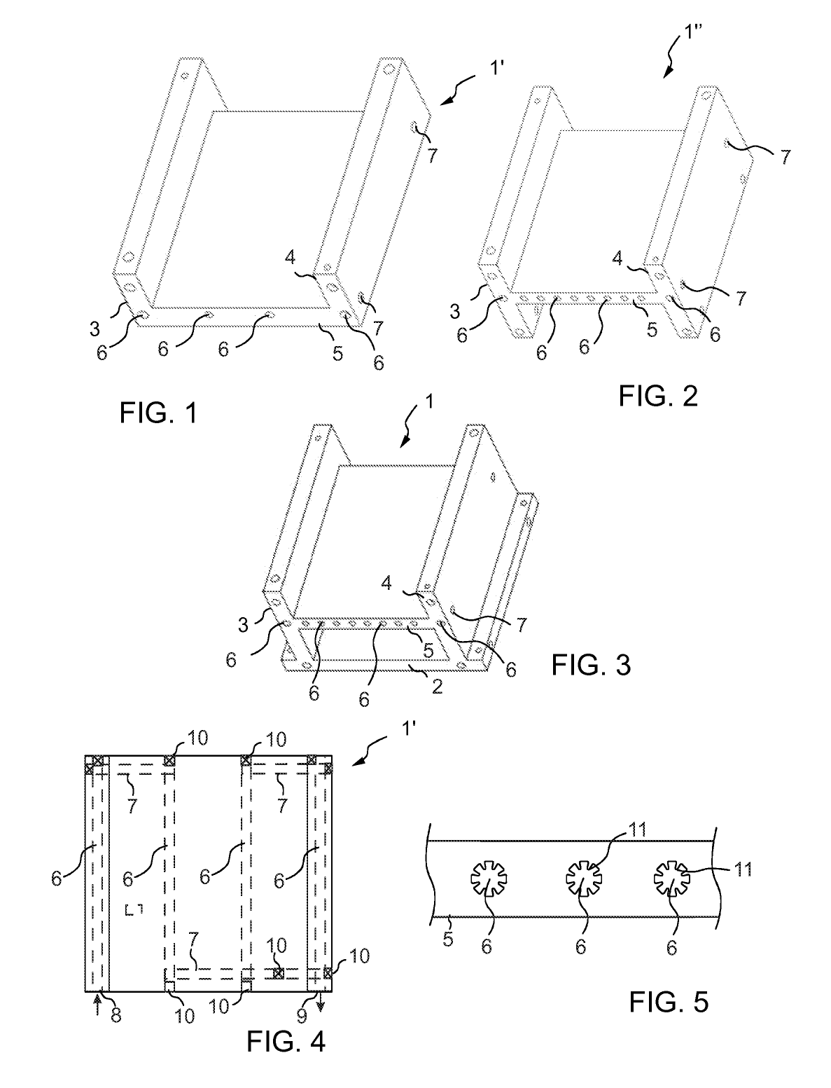

FIGS. 1 to 3 illustrate alternative ways of shaping a frame for an electronic apparatus, according to exemplary embodiments of the present disclosure. In FIG. 1, the frame 1′ has a cross section which is generally U shaped, while the cross section of the frame 1″ in FIG. 2 is generally H shaped. In FIG. 3, the cross section of the frame 1 is also generally H shaped, however, an additional bottom wall 2 is included in the exemplary embodiment of FIG. 3.

Though the shape of the cross sections of the frames 1′, 1″, and 1 is different, in each case the frames are extruded metallic frames 1′, 1″, 1 with walls 2, 3, 4 and 5 that are integrated parts of the extruded metallic frame. Consequently, the walls are fixedly and rigidly attached to each other and are capable of carrying the load of components which are to be installed in the electronic apparatus. A material suitable for use in manufacturing the frame is aluminum, for example.

At least one of the walls is provided with an extruded flow channel for passing a cooling fluid within that respective wall. In the examples of FIGS. 1 to 3, all of the walls 2, 3, 4 and 5 have such flow channels 6, which makes it possible to utilize these walls 2, 3, 4 and 5 as cooling elements by circulating a cooling fluid within them. By providing additional bores 7 by drilling, for example, and by plugging the ends of some of the extruded channels 6, a continuous fluid path can be created within the walls 2, 3, 4 and 5 as is illustrated in FIG. 4, for example. Therefore, the cooling fluid can be circulated within the frame 1′, 1″ or 1 of the electronic apparatus from an inlet arranged outside the electronic apparatus to an outlet arranged outside the electronic apparatus, with no need to provide any fluid connectors within the electronic apparatus. This significantly reduces the risk of a leakage within the electronic apparatus.

FIGS. 4 and 5 illustrate fluid channels in the frame 1′ of FIG. 1. FIG. 4 illustrates the frame 1′ as seen from above. The extruded flow channels 6 have been connected to each other at suitable locations via bores 7 which have been drilled into the frame. In order to provide a flow path from an inlet 8 to an outlet 9, the extruded flow channels 6 and bores 7 have been plugged 10 at suitable locations. In this way, the cooling fluid can be efficiently distributed entirely within the frame 1′ of the electronic apparatus.

FIG. 5 illustrates the cross sectional shape of the extruded flow channels 6 in the frame 1′ of FIG. 1. Due to manufacture by extrusion, the inner surface of the flow channels 6 is not round as in a drilled bore, but instead the inner surface of the flow channels 6 has longitudinal fins 11 protruding from the walls of the flow channels 6. This increases the surface area that comes into contact with the fluid in the flow channels 6. Consequently, heat can be more efficiently transferred from the frame 1′ to the fluid in the flow channels 6.

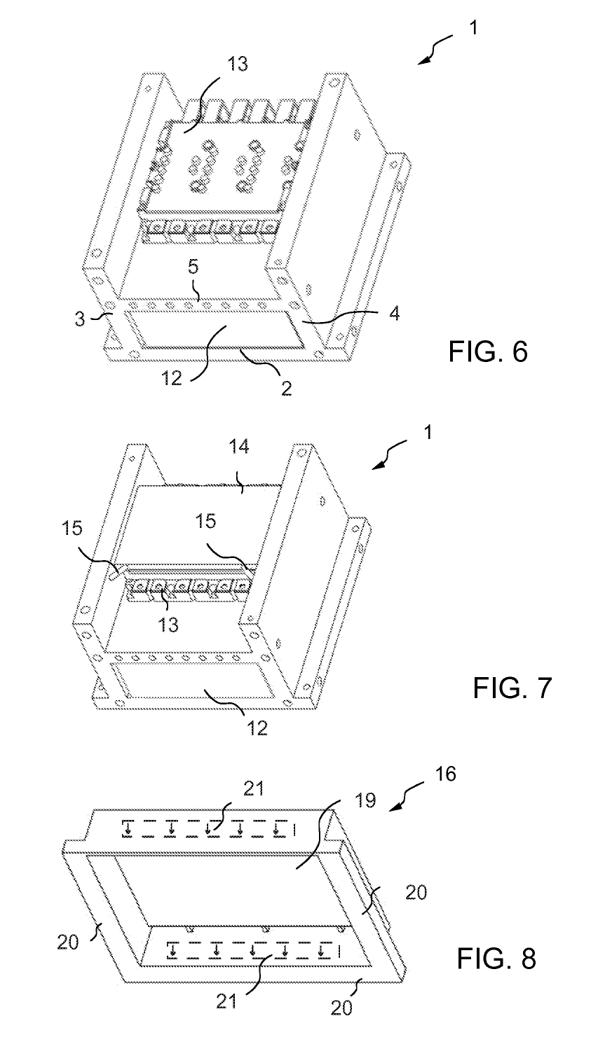

FIGS. 6 and 7 illustrate the location of components in an exemplary embodiment of the present disclosure. In the illustrated example, components have been added to an electronic apparatus including a frame 1 according to FIG. 3. In the following explanation, it is by way of example assumed that the electronic apparatus is a motor drive, such as a frequency converter, which is used for supplying an operating electric power to an electric motor.

In FIG. 6, capacitors 12 have been arranged in a component space which is sealed off by walls 2, 3, 4, 5 and the detachable covers illustrated in FIGS. 8 and 10. In this location, the capacitors 12 are cooled from four different directions, as the cooling fluid can circulate in all of the walls 2, 3, 4, and 5.

A power semiconductor 13 is arranged on top of the wall 5. If necessary, as illustrated in FIG. 7, a separate cooling element 14 may be arranged on top of the power semiconductor 13 in case the cooling provided by the walls 3, 4 and 5 of the frame is not sufficient. In such a case, fluid connectors 15 for passing fluid to a flow channel of the cooling element 14 may be provided in one or more of the surrounding walls 3, 4, and 5.

FIGS. 8 to 10 illustrate examples of detachable covers 16, 17 and 18 which can be attached to the walls 2, 3, and 4 of the frame 1 for sealing off at least one component space from outside of the electronic apparatus. The covers 16, 17, and 18 may be manufactured from aluminum, for example.

The cover 16 illustrated in FIG. 8 has a recess which is utilized as a mounting space for a circuit board 19 containing electric components. Electric connectors and wires may be utilized for connecting the circuit board 19 to the semiconductor 13 and/or the capacitors 12. Edges 20, which come into contact with the walls 2, 3, and 4, are used for conducting heat from the cover 16 to the walls 2, 3, and 4, and further to the cooling fluid circulating in these walls. In order to enhance cooling of the cover 16 and the circuit board 19, heat pipes 21 and/or thermosyphons may be integrated into the cover 16 in order to transfer heat from other parts of the cover 16 towards the edges 20, as illustrated by arrows in FIG. 8.

In case efficient sealing is required between the cover 16 and the walls 2, 3, and 4, it is possible to provide a groove along the edges 20, for example, and a sealing ring into this groove. In such a case, the sealing ring may be dimensioned to flatten in the groove during assembly to such an extent that the material of the cover 16 comes into contact with the material of the walls 2, 3 and 4. In this way, heat transfer between the cover 16 and the walls 2, 3, and 4 is not interrupted by the sealing ring.

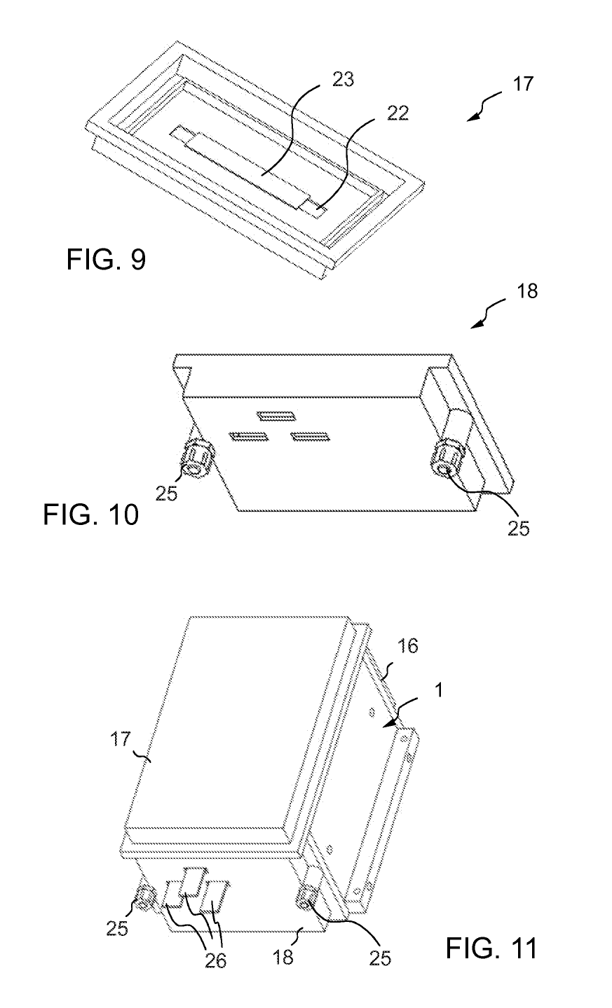

The cover 17 illustrated in FIG. 9 includes a pressure relief area 22 having a reduced strength which enables the cover 17 to break at the pressure relief area 22 when a pressure inside the electronic apparatus reaches a predetermined limit. Due to this, additional damages may be avoided in case the pressure inside the electronic apparatus suddenly increases significantly due to damage in the power semiconductor 13, for example. In case of a cover manufactured of aluminum, for example, a protective steel plate 23 may be attached at the location of the pressure relief area 22.

Similar as to the cover 16, the cover 17 may also be used for housing a circuit board. In such a case, it is also possible to arrange electric connectors along the outer edges of the cover 16 in order to facilitate external electrical connections.

The cover 18 illustrated in FIG. 10 is provided with fluid connectors 25 via which external piping is connected to the inlet 8 and the outlet 9 of the flow path through the extruded metallic frame 1. With such a solution, it is possible to minimize the number of fluid connections that are provided inside the electronic apparatus. In case sufficient cooling is obtained by circulating the cooling fluid completely within walls 2, 3, 4, and 5 of the frame 1 alone, and no additional cooling element is needed, then fluid connectors are not at all needed in the component space or component spaces of the electronic apparatus.

FIG. 11 illustrates an exemplary embodiment of an electronic apparatus according to the present disclosure. In FIG. 11, the covers 16, 17, and 18 are attached to the frame. At this stage, the fluid connectors 25 and the electric connectors 26 are accessible from the outside of the electronic apparatus, which enables an easy installation. The installation may involve mounting of a protective lid to cover connectors 25 and 26.

It will be appreciated by those skilled in the art that the present disclosure can be embodied in other specific forms without departing from the spirit or essential characteristics thereof. The presently disclosed exemplary embodiments are therefore considered in all respects to be illustrative and not restricted. The scope of the disclosure is indicated by the appended claims rather than the foregoing description and all changes that come within the meaning and range and equivalence thereof are intended to be embraced therein.

What is claimed is:

1. An electronic apparatus comprising:
an extruded metallic frame having walls which are integrated parts of the metallic frame,
at least one flow channel in at least one of the walls for passing a cooling fluid within the at least one of the walls, respectively, the at least one flow channel being a flow channel extruded in the at least one of the walls,
an inlet arranged outside the electronic apparatus and an outlet arranged outside the electronic apparatus for providing a flow path via the at least one flow channel, and
detachable covers which are attached to the walls of the metallic frame for sealing off at least one component space from outside of the electronic apparatus, wherein at least one of the detachable covers includes:
an edge which is in contact with the extruded metallic frame; and
at least one of an integrated heat pipe and a thermosyphon for transferring heat from other parts of the detachable cover to the edge which is in contact with the extruded metallic frame for transferring heat from the detachable cover to the cooling fluid in the at least one extruded flow channel.

2. The electronic apparatus according to claim 1, wherein at least one of the detachable covers includes a pressure relief area having a reduced strength to enable the cover to break at the pressure relief area when a pressure inside the electronic apparatus reaches a predetermined limit.

3. The electronic apparatus according to claim 1, wherein an inner surface of the at least one extruded flow channel has longitudinal fins protruding from the walls of the flow channel to increase a surface area contacting the cooling fluid in the flow channel.

4. The electronic apparatus according to claim 1, wherein the flow path for the cooling fluid between the inlet and the outlet is arranged completely within the walls of the extruded metallic frame of the electronic apparatus without passing any fluid via fluid connectors located within the at least one component space of the electronic apparatus.

5. The electronic apparatus according to claim 1, comprising:
a cooling element having a flow channel arranged in the at least one electric component space,
wherein the extruded metallic frame with at least one extruded flow channel in at least one wall includes connectors within the electronic apparatus for passing fluid to the flow channel of the cooling element and for receiving fluid exiting the flow channel of the cooling element.

6. The electronic apparatus according to claim 1, wherein the extruded metallic frame has a cross section which is generally H shaped.

7. The electronic apparatus according to claim 1, wherein the electronic apparatus is a motor drive for controlling supply of electricity to an electric motor.

8. The electronic apparatus according to claim 1, wherein the extruded metallic frame has a cross section which is generally U shaped.

9. The electronic apparatus according to claim 2, wherein an inner surface of the at least one extruded flow channel has longitudinal fins protruding from the walls of the flow channel to increase a surface area contacting the cooling fluid in the flow channel.

10. The electronic apparatus according to claim 9, wherein the flow path for the cooling fluid between the inlet and the outlet is arranged completely within the walls of the extruded metallic frame of the electronic apparatus without passing any fluid via fluid connectors located within the at least one component space of the electronic apparatus.

11. The electronic apparatus according to claim 10, comprising:
a cooling element having a flow channel arranged in the at least one electric component space,
wherein the extruded metallic frame with at least one extruded flow channel in at least one wall includes connectors within the electronic apparatus for passing fluid to the flow channel of the cooling element and for receiving fluid exiting the flow channel of the cooling element.

12. The electronic apparatus according to claim 2, wherein the flow path for the cooling fluid between the inlet and the outlet is arranged completely within the walls of the extruded metallic frame of the electronic apparatus without passing any fluid via fluid connectors located within the at least one component space of the electronic apparatus.

13. The electronic apparatus according to claim 12, comprising:
a cooling element having a flow channel arranged in the at least one electric component space,
wherein the extruded metallic frame with at least one extruded flow channel in at least one wall includes connectors within the electronic apparatus for passing fluid to the flow channel of the cooling element and for receiving fluid exiting the flow channel of the cooling element.

14. The electronic apparatus according to claim 2, comprising:
a cooling element having a flow channel arranged in the at least one electric component space,
wherein the extruded metallic frame with at least one extruded flow channel in at least one wall includes connectors within the electronic apparatus for passing fluid to the flow channel of the cooling element and for receiving fluid exiting the flow channel of the cooling element.
